(19) United States
(12) Patent Application Publication
(10) Pub. No.: US 2005/0135346 A1
(43) Pub. Date: Jun. 23, 2005

(54) Transmitting apparatus

(76) Inventors: Hisashi Oyamada, Kawasaki (JP); Toshihito Kaneshima, Kawasaki (JP)

Correspondence Address: KATTEN MUCHIN ZAVIS ROSENMAN, 575 MADISON AVENUE, NEW YORK, NY, 10022-2585, US

(21) Appl. No.: 11/050,573

(22) Filed: Feb. 3, 2005

Related U.S. Application Data
(63) Continuation of application No. PCT/JP02/12370, filed on Nov. 27, 2002.

(51) Int. Cl. H04L 12/66

(52) U.S. Cl. 370/352

(57) ABSTRACT

A transmitting apparatus provided in a network different from IP comprises IP telephone control means for implementing an IP telephone function by dealing with IP data including audio information; means for capsuling the IP data dealt with by the IP telephone control means into data suitable for the protocol of the network in which the local apparatus is provided; means for transmitting to the network the data capsuled by the capsuling means; means for receiving, via the network, data capsuled by capsuling means of another transmitting apparatus; and means for extracting IP data from the data received by the receiving means.

### BACKGROUND OF THE INVENTION

The present invention relates to a transmitting apparatus that is provided in a network different from IP (Internet Protocol) and realizes a telephone conversation function.

Conventionally, as a function of realizing voice communication between stations existing at mutually remote places in an optical communication network, an order wire function has been used. FIG. 13 shows an example of a conventional order wire system for realizing the order wire function. The order wire system is formed by plural NEs (Network Elements: stations) 1 (1a, 1b, 1c, 1d), a transmission line 2, and telephones 3 (3a, 3b, 3c) connected to the NEs 1. Here,.when communication (including voice communication) between two certain NEs 1 is considered, each NE 1 provided on a communication path is referred to as the “relay station”. The order wire system is mainly used by a maintenance person of an apparatus for the sake of maintenance of the apparatus. The order wire system is realized using the E1/E2 byte of overhead in SONET (Synchronous Optical Network) or SDH (Synchronous Digital Hierarchy).

In the order wire system, voice data originated from the telephone 3a is AD-converted by the NE 1a. Then, the voice data is DA-converted by the NE 1c and new voice data originated from the telephone 3c is added to the voice data. After the addition, the voice data is AD-converted again, is transmitted to the NE 1b, is DA-converted by the NE 1b, and is transmitted to the telephone 3b.

As described above, in the conventional order wire system where the stations are connected in a multistage manner, DA/AD conversion is repeatedly performed at each relay station for the sake of addition of new voice data. Consequently, there occurs degradation of voice quality resulting from the repeatedly performed DA/AD conversion. Therefore, in the conventional order wire system, the number of times of the DA/AD conversion need to be limited, which leads to a problem in that the number of stations that can be multistage-connected is limited.

As a method of solving such a problem, a method called “digital through” has been devised. The digital through is a technique with which a setting is made so that new voice data will not be added (picked up) at each midway station even in multistage connection, thereby realizing end-to-end voice communication. Therefore, with the digital through, there is no need to perform the DA/AD conversion at the time of relay, thereby preventing the voice quality degradation resulting from the repetition of the DA/AD conversion.

With the digital through, however, a setting is made so that new voice data will not be picked up at the time of relay, so there occurs a problem in that voice at each relay station will not be merged. That is, there occurs a problem in that a maintenance person of the relay station can not participate in conversation.

### SUMMARY OF THE INVENTION

The digital through has the aforementioned problem, so a technique different from the digital through is desired with which it is possible to prevent degradation of voice quality in the order wire system. Therefore, the present invention is aimed at providing a transmitting apparatus with which an order wire system where there is no need to limit the number of stations that can be multistage-connected without using the digital through is formed in a network, such as SONET, which is different from IP. That is, the present invention is aimed at providing a transmitting apparatus with which telephone conversation between transmitting apparatuses without causing degradation of voice quality is realized.

In order to solve the above-mentioned problems, the present invention is configured as will be described below. According to a first aspect of the present invention, there is provided a transmitting apparatus provided in a network different from Internet Protocol (IP), including: An IP telephone control unit implementing an IP telephone function by dealing with IP data including voice information; an encapsulating unit the IP data dealt with by the IP telephone control unit into data suitable for a protocol of the network in which this transmitting apparatus is provided; a transmitting unit transmitting the data encapsulated by the encapsulating unit to the network; a receiving unit receiving data encapsulated by the encapsulating unit of another transmitting apparatus, via the network; and an extracting unit extracting IP data from the data received by the receiving unit.

The transmitting apparatus that is the first aspect of the present invention is provided in a network different from IP. As an example of such a network, there is a network by SONET/SDH. Note that when the transmitting apparatus that is the first aspect of the present invention is provided in the network by SONET/SDH, there is a necessity to form the transmitting apparatus as an optical transmitting apparatus.

The IP telephone control unit implements an IP telephone function. More specifically, the IP telephone control unit implements a telephone function based on IP such as H. 323 protocol.

The encapsulating unit encapsulates IP data dealt with by the IP telephone control unit into data suitable for the protocol of the network in which the local apparatus is provided, that is, the network different from IP. As an example of the protocol of the network different from IP, there is OSI.

The transmitting unit transmits the data encapsulated by the encapsulating unit to the network different from IP. The data dealt with by the IP telephone control unit is IP data, so the data can not be transmitted to the network different from IP as it is, while the data encapsulated by the encapsulating unit can be transmitted.

The receiving unit receives data encapsulated by another apparatus into data suitable for the protocol of the network different from IP, via the network different from IP.

The extracting unit extracts encapsulated IP data from the data received by the receiving unit. Processing performed by the extracting unit and processing performed by the encapsulating unit are similar to each other, so these two units may be formed as one unit. That is, these units may be formed as an extracting/encapsulating unit.

The IP telephone control unit implements the IP telephone function by further dealing with the IP data extracted by the extracting unit.

Input and output unit for inputting and outputting voice into and from the IP telephone function may be provided in the transmitting apparatus that is the first aspect of the present invention as necessary or may be provided in another apparatus connected to the transmitting apparatus.

According to the first aspect of the present invention, telephone conversation using the IP telephone function is performed between transmitting apparatuses provided in the network different from IP. Therefore, a telephone conversation system (order wire system) is realized in which there will not occur degradation of voice quality that depends on the number of transmitting apparatuses provided between transmitting apparatuses that perform telephone conversation.

According to the first aspect of the present invention, a transmitting apparatus may be structured such that the transmitting apparatus further includes: a path storing unit storing a communication path to each of other transmitting apparatuses by performing communication with other transmitting apparatus provided in the same network.

Further, according to the first aspect of the present invention, a transmitting apparatus may be structured such that the transmitting apparatus further includes: a path control unit, when a fault occurred to a path of the network, controlling the transmitting unit to transmit the encapsulated data via a path that is stored in the path storing unit excluding the path to which the fault occurred.

Further, according to the first aspect of the present invention, a transmitting apparatus may be structured such that the transmitting apparatus further includes: an IP path storing unit obtaining an IP address of and IP terminal connected to an IP network, to which each of other transmitting apparatuses provided in the same network is connected, by performing communication with other transmitting apparatus, and storing the IP address and other transmitting apparatus so as to be associated with each other.

According to a second aspect of the present invention, there is provided a transmitting apparatus accommodated in a network in which data is transmitted in accordance with a protocol different from Internet Protocol (IP), including: a tunnel generating unit generating tunnels for transferring IP-related data between predetermined transmitting apparatuses accommodated in the network; and a call establishing unit establishing an IP telephone call via the network through cooperation with other transmitting apparatuses accommodated in the network using one or more tunnels generated by the tunnel generating unit.

The present invention is applicable to an industry that provides a service such as maintenance of a network or maintenance of a facility connected to a network.

### BRIEF DESCRIPTION OF THE DRAWINGS

FIG. 1 shows a fundamental structure of an order wire system according to the present invention;

FIG. 2 is a schematic diagram of a structure of an NE;

FIG. 3 is a schematic diagram of an OSI tunnel;

FIG. 4A and FIG. 4B show functional blocks of an OSI tunnel processing section and its periphery;

FIG. 5 shows an H. 323 protocol stack encapsulated by the OSI tunnel;

FIG. 6 shows a system structure in a first application example;

FIG. 7A and FIG. 7B show an operation sequence in the first application example;

FIG. 8 shows a system structure in a second application example;

FIG. 9 shows a system structure in a third application example;

FIG. 10 shows a system structure in a fourth application example;

FIG. 11A and FIG. 11B show an operation sequence in the fourth application example;

FIG. 12 shows a system structure in a fifth application example; and

FIG. 13 shows a conventional order wire system.

### DETAILED DESCRIPTION OF THE INVENTION

Next, a transmitting apparatus in an embodiment of the present invention will be described using the drawings. Note that the description in this embodiment is merely an example and there is no intention to limit the structure of the present invention to the following description.

[System Outline]

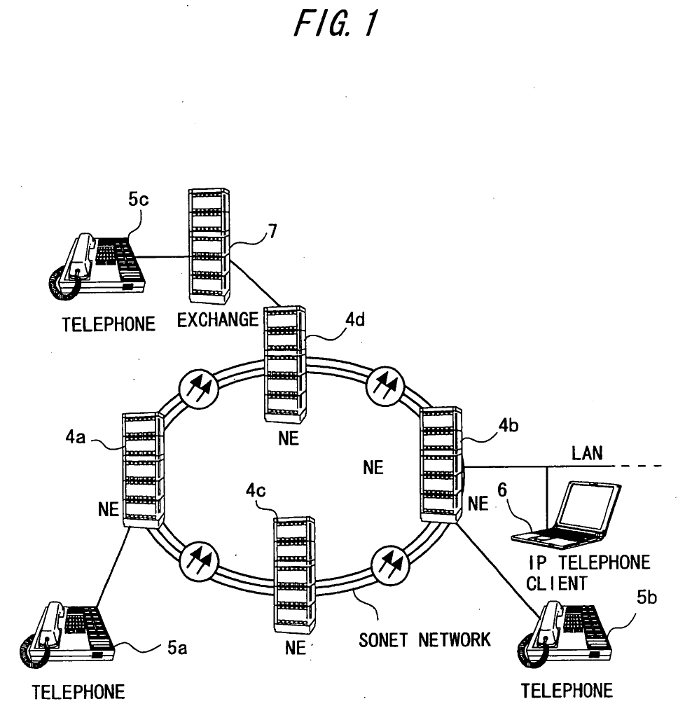

FIG. 1 shows an example of a fundamental structure of an order wire system using NEs that are the embodiment of the transmitting apparatus according to the present invention. The order wire system in FIG. 1 is formed using NEs 4 (4a, 4b, 4c, 4d), telephones 5 (5a, 5b, and 5c), an IP telephone client 6, and an exchange 7. In the order wire system, data of voice communication by IP (data of IP telephone) is exchanged by OSI protocol between the NEs provided in an optical network (SONET network). That is, the IP telephone data is exchanged by utilizing DCC (Data Communication Channel) communication. Also, in the order wire system, in the optical network, a telephone line (order wire) that a maintenance person uses for maintenance is realized by IP telephone.

It should be noted that the structure of the order wire system shown in FIG. 1 is an example of the fundamental structure and may be changed in any way in accordance with system requirements so long as the change does not depart from the structure of the present invention. For instance, first to fourth application examples to be described later are possible.

The telephones 5 are each formed using a conventional analog telephone. The telephones 5a and 5b are connected to the NEs 4a and 4b, respectively. The telephone 5c is connected to a public telephone network in which the exchange 7 is provided.

The IP telephone client 6 is formed using an information processing apparatus on which IP telephone client software is installed, an IP telephone, or the like. The IP telephone client 6 is connected to a LAN to which the NE 4b is also connected. At the IP client 6, the telephone number, alias name of the other party, or the like is designated by a user, and telephone conversation with another IP telephone client 6 or a telephone 5 is made.

The exchange 7 is an exchange of a public telephone network. The exchange 7 is provided in a public telephone network connected to the NE 4d.

The NEs 4 are each formed using an optical transmitting apparatus. The NEs 4 each have at least an OSI automatic routing function and an IP telephone client function. Hereinafter, each function of the NEs 4 will be described.

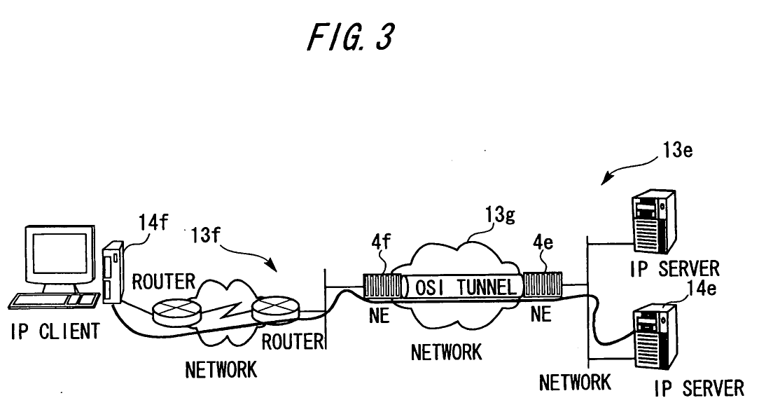

With the OSI automatic routing function, an OSI tunnel that establishes connection between two points is automatically created. FIG. 3 shows the outline of the OSI tunnel. First, using FIG. 3, the OSI tunnel will be described.

Networks 13e and 13f are IP networks that are connected to NEs 4e and 4f, respectively. Here, there is also a case where the NEs 4e and 4f are each formed using a GNE (Gateway NE) or a Mediated GNE. Also, a network 13g is an OSI network connected to the NE 4e and the NE 4f. Therefore, the network 13e and the network 13f are not directly connected to each other in terms of IP. That is, an IP client 14f connected to the network 13f is incapable of directly performing IP communication with an IP server 14e connected to the network 13e.

In an OSI tunnel, the NE 4f stores the IP address of the IP server 14e and the NSAP address (Network Service Access Point address) of the NE 4e so as to be associated with each other. These addresses are set statically by a TL1 command. Also, the NE 4e stores the IP address of the IP client 14f and the NSAP address of the NE 14f so as to be associated with each other. When the NE 4f received an IP packet whose destination address is the IP address of the IP server 14e, it packs the IP packet in an OSI packet (where an NSEL value=0×89 was added to ISO8473 CLNP). The NE 4e transmits the OSI packet to the NE 4e with reference to the NSAP address thereof stored so as to be associated with the IP address of the IP server 14e by utilizing OSI. The NE 4e extracts the IP packet addressed to the IP server 14e from the OSI packet received from the NE 4f and transmits the IP packet to the network 13e. Then, the IP packet reaches the IP server 14e by IP. By following the same procedure, communication from the IP server 14e to the IP client 14f is also performed. As described above, in the OSI tunnel, the IP packet is encapsulated into the OSI packet, thereby achieving communication between the IP networks through the OSI network.

Now, we return to the explanation of the OSI automatic routing function. The transmitting apparatuses having the OSI automatic routing function inform each other of IP networks to which other transmitting apparatuses provided in the OSI network are connected. The contents of information exchanged between the transmitting apparatuses having the OSI automatic routing function are the network addresses of the IP networks, the addresses of IP networks or IP apparatuses that the transmitting apparatuses are capable of reaching, and the like. Here, an IP network that a transmitting apparatus is capable of reaching refers to an IP network to which the transmitting apparatus is capable of transmitting data by IP. That is, an IP network that the transmitting apparatus is capable of accessing by IP. The transmitting apparatuses having the OSI automatic routing function store the exchanged information in their IP routing tables. Then, the transmitting apparatuses having the OSI automatic routing function automatically construct OSI tunnels as necessary based on the exchanged IP information (automatic OSI tunnel creation function). As a result, it becomes possible to automatically utilize IP communication in the OSI network via OSI (DCC byte).

Next, the IP telephone client function will be described. The transmitting apparatuses having the IP telephone client function have an IP telephone (IP telephony or Voice Over IP) function of communicating voice data using IP. This function is standardized by ITU-T H. 323 or the like, and a gatekeeper, a gateway, an inter-multipoint communication control unit, and the like are required as system elements when the function based on H. 323 is realized.

In each transmitting apparatus having the IP telephone client function, the address or alias name of each of one or more gatekeepers is registered. The transmitting apparatus registers itself in the gatekeepers, and the gatekeepers register data concerning the transmitting apparatus in their registration tables. When the transmitting apparatus issues a telephone conversation request to a gatekeeper registered in itself using the telephone number or alias name of the other party, the gatekeeper searches the registration table for an IP address corresponding to the other party to whom the telephone conversation request was made, and returns the IP address to the transmitting apparatus. Then, the transmitting apparatus establishes connection with the other party using the obtained IP address. When the other party is a telephone connected to a public telephone network, digital voice data is converted into analog data by the gateway.

The NEs 4 may further have a gatekeeper function, a gateway function, an IP routing function, and an inter-multipoint communication function in addition to the OSI automatic routing function and the IP telephone client function.

The gatekeeper function is a gatekeeper function under ITU-T H. 232 and performs conversion between a telephone number or an alias name and an IP address, band management, authentication for band usage, and the like. A protocol that implements the gatekeeper function is an RAS (Registration, Admission, Status) protocol (hereinafter referred to as the “RAS”) and each information element is transmitted as a stream to other end points (including gatekeepers) by this protocol.

The gateway function is a gateway function under ITU-T H. 232 and performs AD conversion of voice, mediation of call establishment, and the like using a CODEC (Coder-Decoder) pursuant to plural specifications such as G. 711.

The IP routing function is a function of routing IP packets in accordance with IP.

The inter-multipoint communication function is a function that supports a conference between three or more end points.

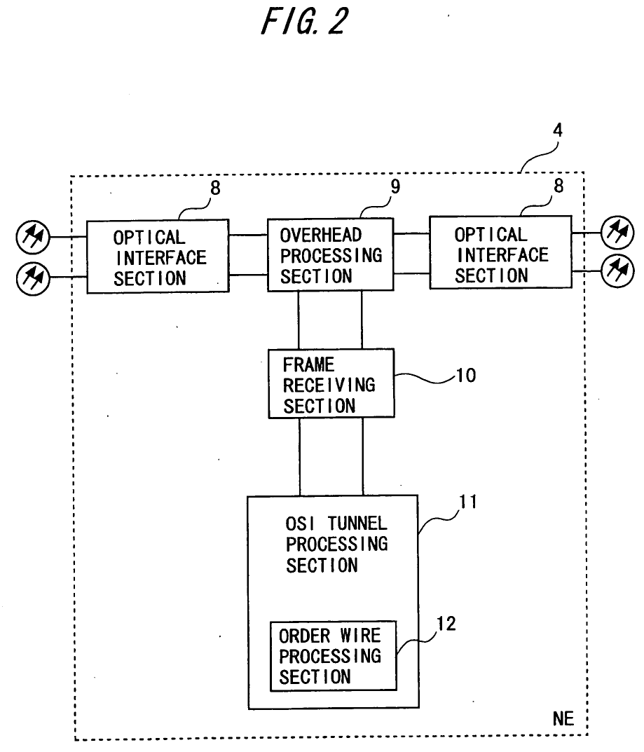

Next, functional blocks of the NE 4 will be described. FIG. 2 is a schematic diagram of a structure of the NE 4. In terms of hardware, the NE 4 includes a CPU, a main memory (RAM), an auxiliary storage apparatus (hard disk, EPROM, EEPROM, NVRAM), and the like that are connected to each other via a bus. Through loading of various programs (OS, applications, and the like) stored in the auxiliary storage apparatus into the main memory and execution of the programs by the CPU, the NE 4 functions as an apparatus including optical interface sections 8, an overhead processing section 9, a frame receiving section 10, an OSI tunnel processing section 11, an order wire processing section 12, and the like.

Each optical interface section 8 is formed using an optical interface card of OC3 or the like, for instance. The optical interface section 8 performs input and output of data with respect to the SONET network. The optical interface section 8 exchanges information of overhead bytes such as E1 or E2, control information, and DCC data with the overhead processing section 9.

The overhead processing section 9 is formed using an overhead extraction LSI such as an OHF48-LSI. The overhead processing section 9 receives data from the optical interface section 8 and extracts overhead data, such as E1/E2 or D1/D2, from the received data. Then, the overhead processing section 9 passes the extracted overhead data to the order wire processing section 12. Also, the overhead processing section 9 passes the DCC data to the frame receiving section 10.

The frame receiving section 10 is formed using an LSI (frame LSI) that receives frames of HDLC or the like, for instance. The frame receiving section 10 passes the data received from the overhead processing section 9 to the OSI tunnel processing section 11.

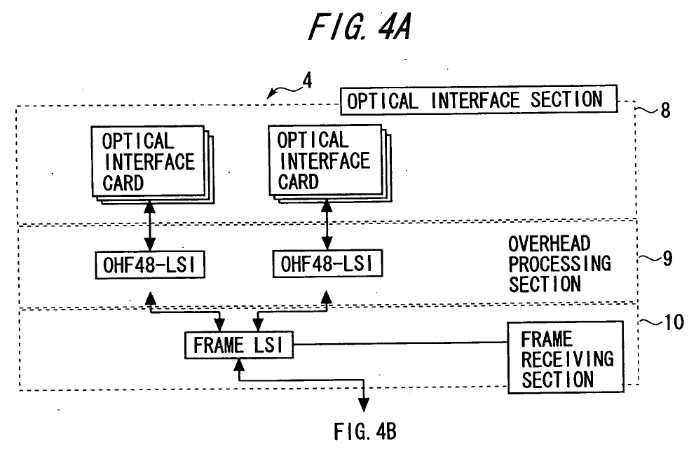

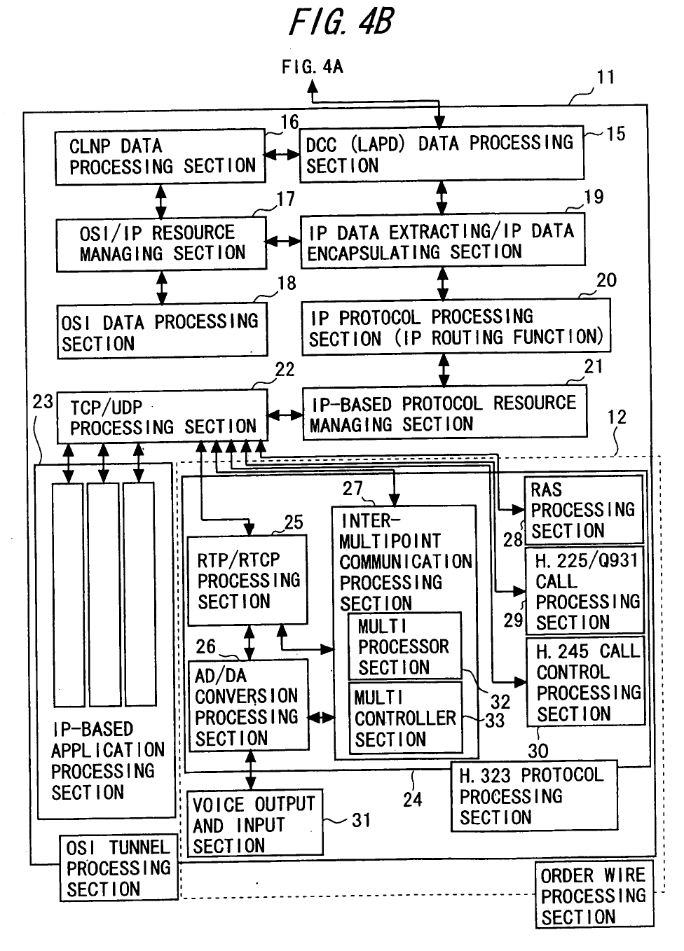

The OSI tunnel processing section 11 performs OSI tunnel processing. FIG. 4A and FIG. 4B show functional blocks of the OSI tunnel processing section 11 and its periphery. In order to perform the OSI tunnel processing described above, the OSI tunnel processing section 11 includes a DCC data processing section 15, a CLNP data processing section 16, an OSI/IP resource managing section 17, an OSI data processing section 18, an IP data extracting/IP data encapsulating section 19, an IP protocol processing section 20, an IP-based protocol resource managing section 21, a TCP/UDP processing section 22, an IP-based application processing section 23, and the order wire processing section 12.

The DCC data processing section 15 receives the DCC data from the frame receiving section 10.

The CLNP data processing section 16 processes ISO8473, ISO9542, and ISO10589.

The OSI/IP resource managing section 17 judges the type of data in CLNP and distinguishes between data of TP4 (Transport Protocol Class 4) and data of IP. The OSI/IP resource managing section 17 checks whether the amount of data of TP4 that is currently waiting to be processed exceeds a certain threshold value, and when the threshold value is exceeded, processes the TP4 data with a higher priority. Also, it is possible for a user to give a higher priority to IP data or change the threshold value through setting of the OSI/IP resource managing section 17.

The OSI data processing section 18 processes packets of TP4 or TARP (Terminal Identifier Address Resolution Protocol).

The IP data extracting/IP data encapsulating section 19 extracts data for IP telephone from the DCC data. Hereinafter, processing of the IP data extracting/IP data encapsulating section 19 will be described in a concrete manner.

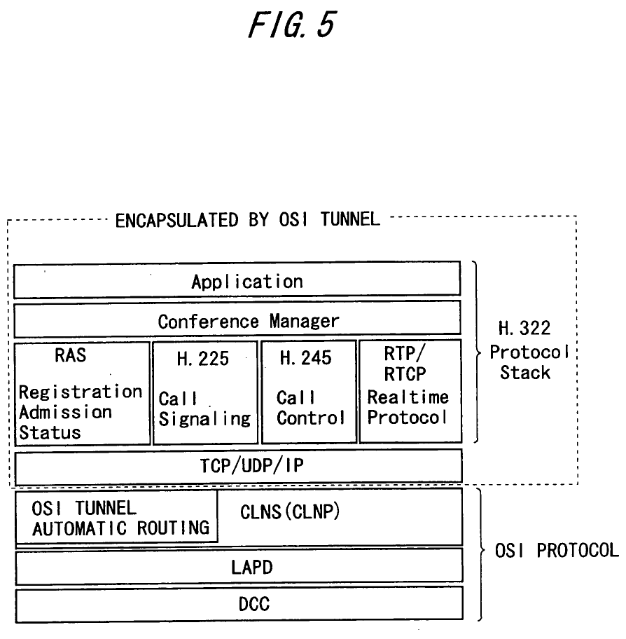

FIG. 5 shows an H. 323 protocol stack encapsulated by the OSI tunnel. Under an OSI tunnel automatic routing protocol, IP routing information is exchanged over the OSI network, and the OSI tunnel is automatically constructed. When an OSI tunnel function and a function of automatically creating the OSI tunnel (automatic OSI tunnel creation function) are used as a method of transferring IP data over DCC, the H. 323 protocol stack encapsulated by the OSI tunnel becomes a stack shown in FIG. 5. The IP data extracting/IP data encapsulating section 19 extracts CLNS PDU (CLNS Protocol Data Unit) from DCC data and extracts IP data from the extracted CLNS PDU. Also, the IP data extracting/IP data encapsulating section 19 performs processing that is reverse to the processing described above. That is, the IP data extracting/IP data encapsulating section 19 also performs processing for encapsulating IP data into DCC data.

The IP protocol processing section 20 processes the IP protocol extracted from the OSI protocol and realizes the IP routing function. More specifically, in this embodiment, the IP protocol processing section 20 realizes the OSI automatic routing function.

The IP-based protocol resource managing section 21 judges the service kind of received IP data in order to secure a system resource (such as a CPU time) to be used in IP telephone. When the service kind of the received IP data is an IP telephone voice data service, the IP-based protocol resource managing section 21 performs processing for passing the IP data to the order wire processing section 12 with the highest priority (IP telephone data priority processing function).

On the other hand, when the service kind of the received IP data is a service other than IP telephone voice data, the IP-based protocol resource managing section 21 temporarily stores the IP data in a buffer (data storing function for a service other than IP telephone). Following this, when intervals between processing of IP telephone voice data are widened (when telephone traffic is reduced, when silent periods occur, or the like), the IP-based protocol resource managing section 21 performs processing of the stored IP data (that is, IP data that is a service other than IP telephone voice data) by utilizing the widened intervals, that is, idle periods.

Also, when the storing period of the stored IP data exceeds a certain period (threshold value), the IP-based protocol resource managing section 21 discards the IP data (stored data discarding function). It is possible for the user to set this threshold value for each service (protocol). With this function, only data having any meaning to the user is processed and processing unnecessary for the user is omitted. Accordingly, effective utilization of system resources and lines becomes possible.

The TCP/UDP processing section 22 processes TCP (Transmission Control Protocol) and UDP (User Datagram Protocol) protocol.

The IP-based application processing section 23 processes application protocols such as FTP (File Transfer Protocol), Telnet, and HTTP (Hypertext Transfer Protocol).

In order to perform order wire processing, the order wire processing section 12 includes an H. 323 protocol processing section 24 and a voice output and input section 31. Also, in order to perform H. 323 protocol processing, the H. 323 protocol processing section 24 includes an RTP/RTCP processing section 25, an AD/DA conversion processing section 26, an inter-multipoint communication processing section 27, an RAS processing section 28, an H. 225/Q931 call processing section 29, and an H. 245 call control processing section 30.

The RTP/RTCP processing section 25 processes RTP (Real-Time Transport Protocol) that transmits and receives voice data and RTCP (RTP Control Protocol) that controls the RTP.

The AD/DA conversion processing section 26 performs analog-digital conversion of voice data. For instance, the AD/DA conversion processing section 26, performs encoding/decoding based on a compression standard such as G. 711 or G. 723. That is, the AD/DA conversion processing section 26 also operates as a CODEC.

The inter-multipoint communication processing section 27 is formed using a unit that implements an H. 323 inter-multipoint communication function, that is, an MCU (Multipoint Control Unit). The MCU includes an MP section (Multi Processor section) 32 and an MC section (Multi Controller section) 33.

The MP section 32 processes a media stream. The MP section 32 receives voice data from an end point and performs necessary synthesis, switching, and other processing. Then, the MP section 32 distributes a stream including this voice data to participants of inter-multipoint communication.

The MC section 33 controls the inter-multipoint communication. The MC section 33 performs communication and call parameter setting with respect to each end point participating in the inter-multipoint communication. Then, the MC section 33 controls resources for the inter-multipoint communication such as multicast.

The RAS processing section 28 performs RAS processing. That is, the RAS processing section 28 performs processing as to registration, communication permission, and communication status detection.

The H. 225/Q931 call processing section 29 performs line establishment processing using an H. 225 procedure. This H. 225 procedure is very similar to Q931.

The H. 245 call control processing section 30 performs call control by receiving and transmitting terminal capability information and a channel setting procedure from and to a terminal.

The voice output and input section 31 performs voice output and input.

### FIRST APPLICATION EXAMPLE

<System Structure>

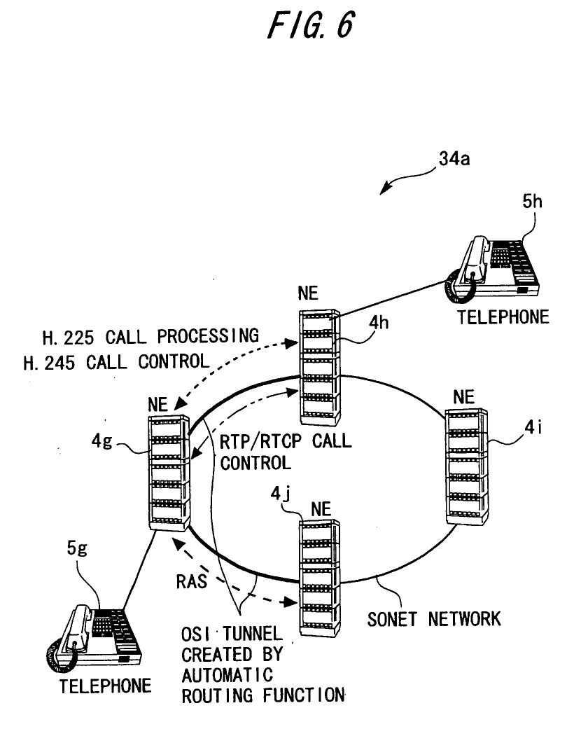

FIG. 6 shows a system structure in a first application example of the NEs 4 (4g, 4h, 4i, and 4j) formed using the transmitting apparatus according to the present invention. That is, a system structure of an order wire system 34a to which the NEs 4 are applied. First, using FIG. 6, system structure in the first application example will be described.

In the order wire system 34a, communication in an optical network (SONET/SDH) is performed. That is, in the order wire system 34a, telephone conversion by IP telephone is performed in the optical network. Therefore, the order wire system 34a is formed using the NEs 4g, 4h, 4i, and 4j constituting the SONET network and telephones 5g and 5h, with the telephones 5g and 5h being directly connected to the NEs 4g and 4h, respectively. In this case, the NEs 4g and 4h each have the IP telephone client function. Also, in the order wire system 34a, an apparatus having the gatekeeper function is necessary and the NE4j has this function. This gatekeeper function may be possessed by another NE 4 or may be possessed by another apparatus (apparatus dedicated to the gatekeeper function, for instance) that is different from the NEs 4 and is accessible from the NEs 4. Also, it is assumed that registration in the gatekeeper as to the IP telephone client function of the NEs 4g and 4h is completed.

### OPERATION EXAMPLE

Hereinafter, an operation example of the order wire system 34a in the first application example will be described. In the following description, an operation under normal conditions and an operation under fault conditions will be described separately.

<<Operation under Normal Condition>>

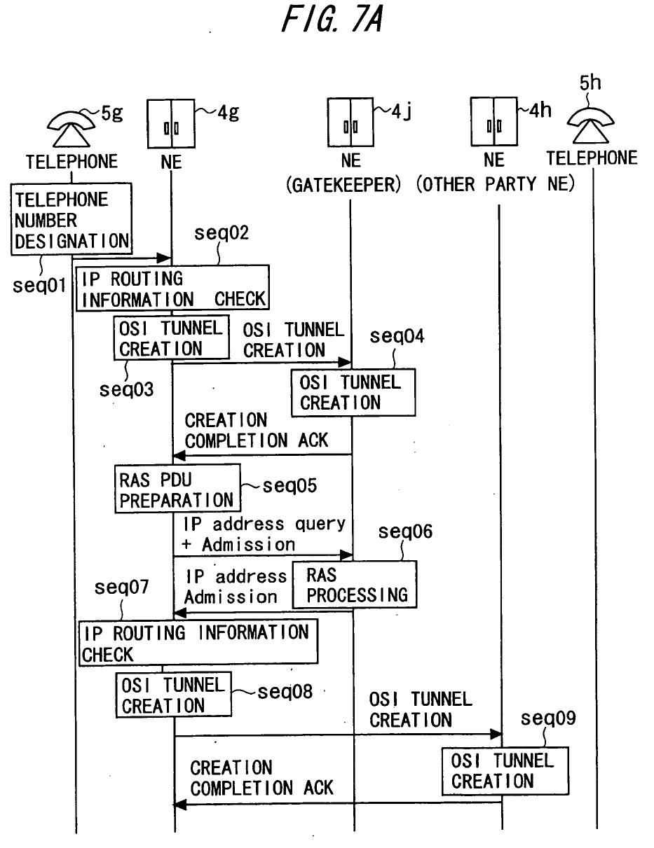

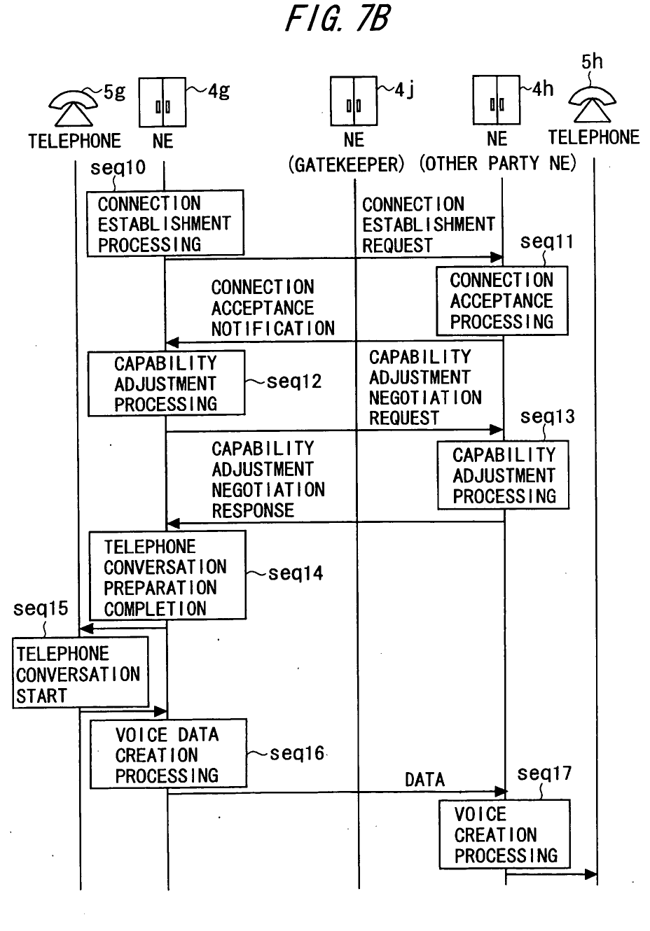

FIG. 7A and FIG. 7B show an operation sequence under normal conditions of the order wire system 34a in the first application example. Using FIG. 7A and FIG. 7B, an operation example of the order wire system 34a in the first application example will be described. Note that the operation sequence in FIG. 7A and FIG. 7B is an operation sequence until telephone conversation from the telephone 5g to the telephone 5h is started.

First, a user designates (inputs) the telephone number or alias name of the NE 4h, which is an IP telephone client to which the telephone 5h that will become the other party of telephone conversation is to be connected, using the telephone 5g (seq 01).

Next, the NE 4g checks whether a route to the IP address of the gatekeeper registered in the local apparatus in advance (that is, in the first application example, the IP address of the NE 4j) exists in the IP routing table constructed by the OSI automatic routing function (seq 02). When the route to the IP address of the NE 4j exists in the IP routing table, the NE 4g creates an OSI tunnel between the NE 4g and the NE 4j using the automatic OSI tunnel creation function. When doing so, in the NE 4g and the NE 4j, the IP protocol processing section 20 executes the automatic OSI tunnel creation function (seq 03, seq 04). When the OSI tunnel creation is completed, the NE 4j issues a creation completion ACK to the NE 4g. The creation completion ACK is a confirmation response (Acknowledgement) for informing that the OSI tunnel creation is completed.

On the other hand, when the route to the IP address of the NE 4j does not exist in the IP routing table, the NE 4g informs the telephone 5g of an error and ends the processing.

When an IP route (OSI tunnel) to the NE 4j (gatekeeper) is created, the RAS processing section 28 of the NE 4g issues a telephone conversation other party (NE4h) IP address obtainment request and a band usage permission request to the NE 4j using RAS protocol. When doing so, the NE 4g informs the NE 4j of the telephone number or alias name designated by the user as the telephone conversation other party IP address obtainment request. When doing so, the IP data extracting/IP data encapsulating section 19 encapsulates IP data that is a target of communication into CLNS PDU under OSI protocol, thereby issuing the telephone conversation other party (NE 4h) IP address obtainment request and the band usage permission request (seq 05). The protocol stack of the data encapsulated into the CLNS PDU is as shown in FIG. 5.

The NE 4j issues, as a gatekeeper, a response with respect to the requests received from the NE 4g. That is, the NE 4j informs the NE 4g of an IP address corresponding to the designated destination telephone number or alias name (that is, the IP address of the NE 4h) and band usage permission (Admission) (seq 06).

The NE 4g checks whether a route to the IP address obtained from the NE 4j (that is, the IP address of the NE 4h) exists in the IP routing table constructed by the OSI automatic routing function (seq 07). When the route to this IP address exists in the IP routing table, the NE 4g creates an OSI tunnel between the NE 4g and the NE 4h using the automatic OSI tunnel creation function. When doing so, in the NE 4g and the NE 4h, the IP protocol processing section 20 executes the automatic OSI tunnel creation function (seq 08, seq 09). When the OSI tunnel creation is completed, the NE 4h issues a creation completion ACK to the NE 4g.

On the other hand, when the route to this IP address does not exist in the IP routing table, the NE 4g informs the telephone 5g of an error and ends the processing.

The NE 4g performs call establishment (connection establishment) with respect to the NE 4h using the H. 225 procedure through the created OSI tunnel (seq 10). After a call is set up by connection acceptance processing (seq 11), the NE 4g and the NE 4h determine a communication method (such as the specifications of a CODEC to be used) using H. 245 protocol (capability adjustment processing: seq 12, seq 13). That is, the NE 4g issues a capability adjustment negotiation request to the NE 4h using H. 245 protocol. Then, the NE 4h issues a capability adjustment negotiation response to the NE 4g with respect to the request. On receiving the capability adjustment negotiation response, the NE 4g judges that a telephone conversation preparation is completed (seq 14).

Following this, telephone conversation is started between the telephone 5g and the telephone 5h using the IP telephone client function in the NE 4g and the NE 4h (seq 15). More specifically, analog voice data inputted from the telephone 5g is inputted into the NE 4g. The NE 4g performs voice data creation processing (seq 16). That is, the NE 4g performs voice communication with the NE 4h using the communication method determined in the capability adjustment processing. For instance, in accordance with the CODEC specifications determined in the capability adjustment processing, the NE 4g creates digital voice data by performing AD conversion on the voice data inputted from the telephone 5g. Then, the NE 4g transmits this digital voice data to the NE 4h using RTP/RTCP. The NE 4h receives the transmitted digital voice data and DA-converts the received data in accordance with the CODEC specifications determined in the capability adjustment processing (voice creation processing: seq 17), thereby creating analog voice data. Then, the NE 4h transmits the created analog voice data to the telephone 5h.

<<Operation under Fault Condition>>

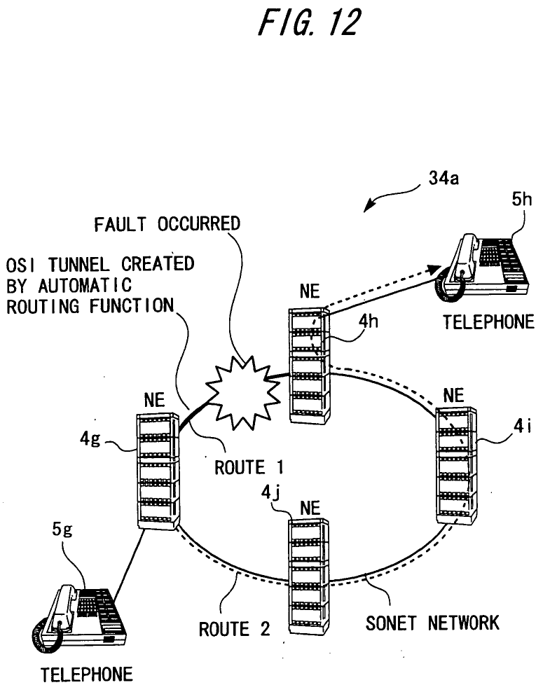

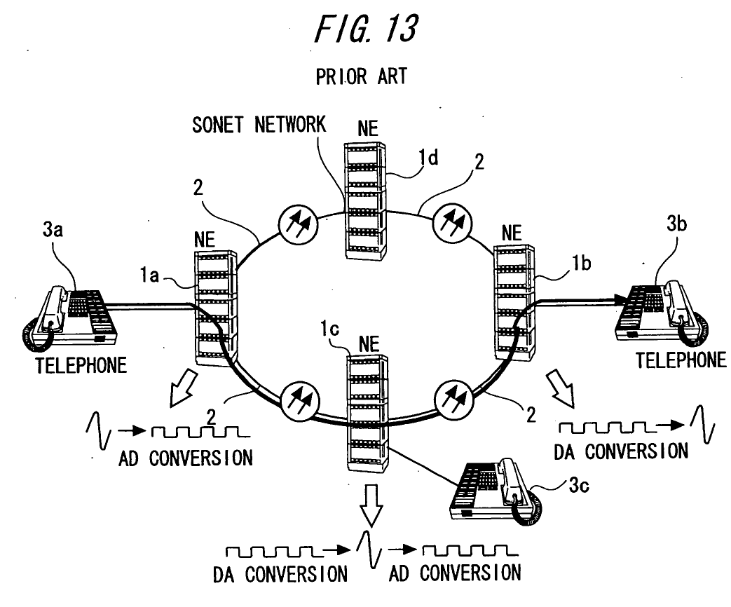

FIG. 12 shows a state where a fault occurred in the order wire system 34a. Using FIG. 12, an operation under fault conditions of the order wire system 34a will be described.

In the order wire system 34a, when a fault has occurred to the network (SONET network) during telephone conversation by IP telephone, a telephone conversation line is relieved. Here, it is assumed that during telephone conversation by IP telephone between the telephone 5g and the telephone 5h after the operation shown in FIG. 7A and FIG. 7B, a fault (such as line cut) occurred to a line connecting the NE 4g and the NE 4h to each other.

When a fault occurs to the line, the NE 4g becomes incapable of receiving Hello PDU of ISO10589 from its adjacent station (NE 4h) through the line to which the fault occurred. Accordingly, the NE 4g judges that a fault occurred to the line between the NE 4g and the NE 4h. Therefore, the NE 4g deletes a route (Route 1) by the line, to which the line cut occurred, from its IS-IS routing table (Intermediate System-to-Intermediate System routing table). Therefore, a route connecting the NE 4g and the NE 4h to each other becomes only a route (Route 2) involving the NE 4j and the NE 4i. Accordingly, CLNS PDU is automatically transferred from the NE 4g to the NE 4h by a new route (Route 2).

<Operation/Effect>

According to the first application example of the present invention, telephone conversation by a user (maintenance person) is realized using the IP telephone client function. In IP telephone, data encoded into digital data will not be decoded until it is received by a destination IP telephone client. Therefore, voice quality will not be influenced by the number of NEs (relay stations). Accordingly, there is no need to take degradation of voice quality into consideration, there by eliminating the necessity to limit the number of relay stations, and convenience is improved.

Also, in the conventional order wire system, no mechanism for rerouting voice data exists, so there is a problem in that it is impossible to save voice data when a fault occurred to a line. According to the first application example of the present invention, however, the NEs 4 have the OSI automatic routing function, so voice data is automatically rerouted when a line fault occurs. Accordingly, telephone conversation by IP telephone is continued by circumventing a route in which a fault occurred. That is, voice data is saved and telephone conversation reliability is improved.

Also, in the conventional order wire system, there is a problem in that a setting of software with respect to hardware is cumbersome. According to the first application example of the present invention, however, telephone conversation is realized by the IP telephone client function, so a setting with respect to hardware becomes simple and it becomes possible to simplify a setting operation by a user. More specifically, according to the first application example of the present invention, only an Enable setting of a DCC communication LSI is required and therefore simplification of a setting is realized.

Also, in the conventional order wire system, a fixed CODEC (G. 711 μ-law) is used. Therefore, there is a problem in that it is impossible to establish connection with an order wire using a transmitting apparatus in a region (Europe, for instance) where a different CODEC is used. According to the first application example of the present invention, however, plural CODECs, such as A-law and μ-law of G. 711 and G. 723 (G. 261 and G. 263 in the case of video), are supported. Accordingly, it becomes possible to absorb regional differences in CODEC system and there will occur no problem at the time of interconnection with a transmitting network in a different region. In addition, there is no necessity to localize the transmitting apparatus of the present invention in accordance with its installation region, which simplifies its installation work.

### SECOND APPLICATION EXAMPLE

<System Structure>

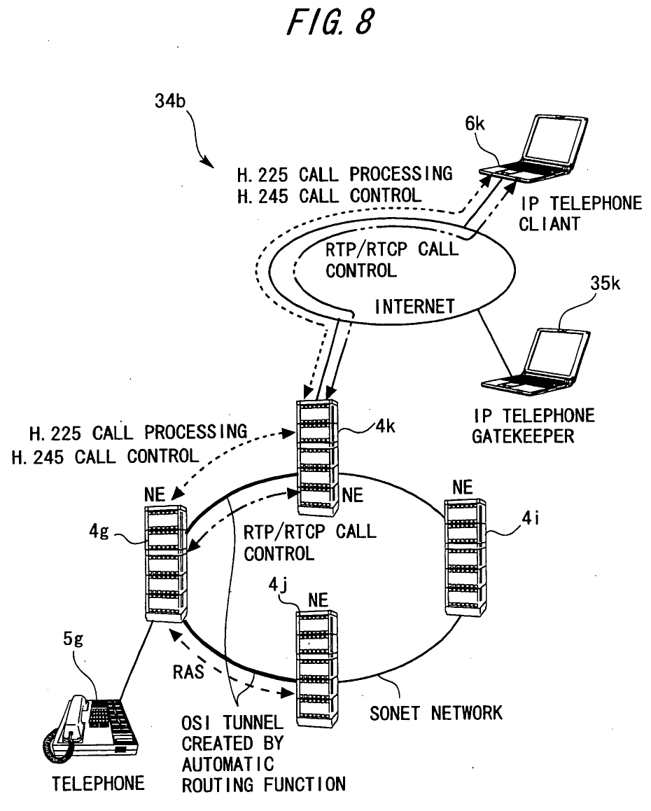

FIG. 8 shows a system structure in a second application example of the NEs 4 (4g, 4k, 4i, and 4j) formed using the transmitting apparatus according to the present invention. That is, a system structure of an order wire system 34b to which the NEs 4 are applied. First, using FIG. 8, the system structure in the second application example will be described.

In the order wire system 34b, telephone conversation by IP telephone is performed between a telephone 5g connected to the NE 4g provided in an optical network (SONET/SDH) and an IP telephone client 6k in the Internet. Therefore, the order wire system 34b is formed using the NEs 4g, 4k, 4i, and 4j constituting the SONET network, the telephone 5g, the IP telephone client 6k connected to the Internet, and an IP telephone gatekeeper 35k connected to the Internet.

The telephone 5g is directly connected to the NE 4g and the Internet is connected to the NE 4k. In this case, the NE 4g has the IP telephone client function. Also, the NE 4k has the IP routing function. Also, in the order wire system 34b, an apparatus having the gatekeeper function is necessary and the NE 4j has this function. This gatekeeper function may be possessed by another NE 4 or may be possessed by another apparatus (for instance, an apparatus dedicated to the gatekeeper function: IP telephone gatekeeper 35k) that is different from the NEs 4 and is accessible from the NEs 4. Also, it is assumed that registration in the gatekeeper as to the IP telephone client function of the NE 4g and the IP telephone client 6k is completed.

### OPERATION EXAMPLE

Next, an operation example of the order wire system 34b in the second application example will be described. In the following description, only operations that are different from those in the first application example will be explained. Here, the telephone 5h and the NE 4k in the first application example correspond to the IP telephone client 6k in the second application example. Therefore, for instance, in seq 01 in the first application example, according to the second application example, a user designates the telephone number or alias name of the IP telephone client 6k on the Internet. In a like manner, the IP address of the other party of telephone conversation in the first application example corresponds to the IP address of the IP telephone client 6k in the second application example.

In seq 03 and seq 04 in the first application example, according to the second application example, when a route to the IP address of the NE 4j or the IP telephone gatekeeper 35k provided on the Internet exists in the IP routing table, the NE 4g creates an OSI tunnel between the NE 4g and the NE 4j or an NE (NE 4k, for instance), which is capable of routing IP data to the IP telephone gatekeeper 35k provided on the Internet, using the automatic OSI tunnel creation function. When doing so, in the NE 4g and the NE 4j or the NE 4k, the IP protocol processing section 20 executes the automatic OSI tunnel creation function.

Also, in seq 08 and seq 09 in the first application example, according to the second application example, when a route to the IP address of the IP telephone client 6k that is the other party of telephone conversation exists in the IP routing table, the NE 4g creates an OSI tunnel between the NE 4g and an NE that is capable of routing (transferring) IP data to the IP telephone client 6k, that is, the NE 4k using the automatic OSI tunnel creation function. When doing so, in the NE 4g and the NE 4k, the IP protocol processing section 20 executes the automatic OSI tunnel creation function.

Also, in the second application example, the processing in seq 12 and later in the first application example is performed between the NE 4g and the IP telephone client 6k instead of between the NE 4g and the NE 4h in the first application example.

<Operation/Effect>

In the conventional order wire system, a call establishment function that IP telephone supports is not supported, so telephone conversation via the Internet is not realized. Therefore, conventionally, when a maintenance person wants to make telephone conversation with another maintenance person that is the other party via the Internet, it is required for him/her to use a facility (mobile telephone, for instance) that is different from the order wire system. There is a case where a system, such as a mobile telephone, is used for a customer service or the like and a situation where such a customer line is used for maintenance is problematic. Also, an increase in cost (telephone charge, for instance) resulting from the usage of a system, such as a mobile telephone, is also problematic.

According to the second application example of the present invention, however, telephone conversation is realized using a standard such as H. 225 of H. 323 or Q. 931, so connection with the Internet becomes possible. Therefore, it becomes possible for a maintenance person to make telephone conversation with another maintenance person that is the other party via the Internet using the IP telephone client function, which eliminates the necessity to use another facility. Accordingly, it becomes possible to reduce costs relating to the usage of other facilities.

### THIRD APPLICATION EXAMPLE

<System Structure>

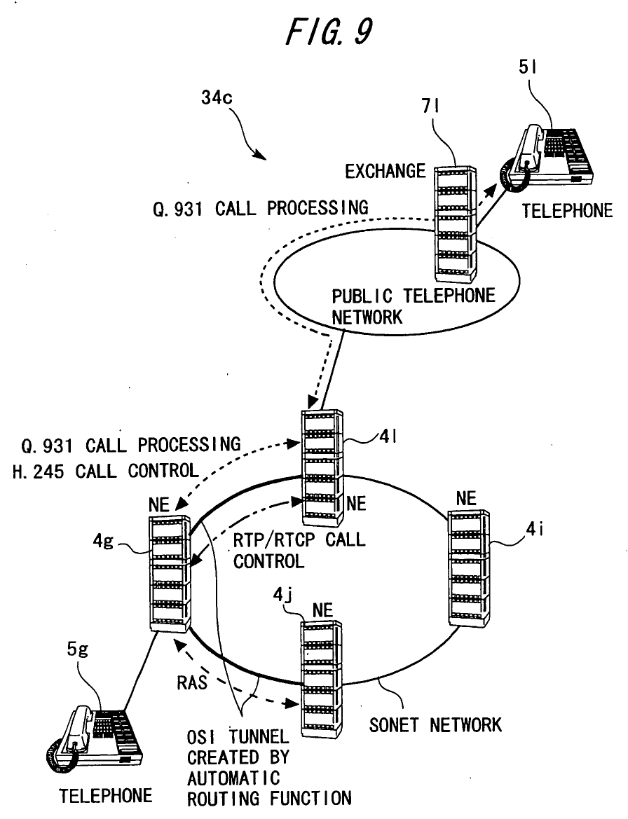

FIG. 9 shows a system structure in a third application example of the NEs 4 (4g, 4l, 4i, 4j) formed using the transmitting apparatus according to the present invention. That is, a system structure of an order wire system 34c to which the NEs 4 are applied. First, using FIG. 9, the system structure in the third application example will be described.

In the order wire system 34c, telephone conversation is performed between a telephone 5g connected to the NE 4g provided in an optical network (SONET/SDH) and a telephone 5l in the public telephone network. Therefore, the order wire system 34c is formed using the NEs 4g, 4k, 4i, and 4j constituting the SONET network, the telephones 5g and 5l, and an exchange 7l connected to the public telephone network.

The telephone 5g is directly connected to the NE 4g and the telephone 5l is connected to the exchange 7l. That is, the telephone 5l is connected to the public telephone network. In this case, the NE 4g has the IP telephone client function. Also, the NE 4l has the gateway function. Also, in the order wire system 34c, an apparatus having the gatekeeper function is necessary and the NE 4j has this function. This gatekeeper function may be possessed by another NE 4 or maybe possessed by another apparatus (apparatus dedicated to the gatekeeper function, for instance) that is different from the NEs 4 and is accessible from the NEs 4. Also, it is assumed that registration in the gatekeeper as to the IP telephone client function of the NE 4g, the telephone 5l, and the like is completed.

### OPERATION EXAMPLE

Next, an operation example of the order wire system 34c in the third application example will be described. In the following description, only operations that are different from those in the first application example will be explained. Here, the telephone 5h and the NE 4k in the first application example correspond to the telephone 5l in the third application example. Therefore, for instance, in seq 01 in the first application example, according to the third application example, a user designates the telephone number of the telephone 5l on the public telephone network.

In seq 03 and seq 04 in the first application example, according to the third application example, when a route to the IP address of the NE 4j exists in the IP routing table, the NE 4g creates an OSI tunnel between the NE 4g and the NE 4j using the automatic OSI tunnel creation function. When doing so, in the NE 4g and the NE 4j, the IP protocol processing section 20 executes the automatic OSI tunnel creation function.

Also, in seq 05 in the first application example, according to the third application example, when an IP route (OSI tunnel) to the NE 4j (gatekeeper) is created, the RAS processing section 28 of the NE 4g issues a request to obtain the IP address of the NE (NE 4l) that is a gateway capable of exchanging data with the other party of telephone conversation (telephone 5l) and a band usage permission request to the NE 4j using RAS protocol. When doing so, the NE 4g informs the NE 4j of the telephone number designated by the user as the IP address obtainment request.

The NE 4j issues, as a gatekeeper, a response with respect to the requests received from the NE 4g. That is, the NE 4j informs the NE 4g of the IP address corresponding to the requested destination telephone number (that is, the IP address of the NE 4l) and band usage permission (seq 06).

The NE 4g checks whether a route to the IP address obtained from the NE 4j (that is, the IP address of the NE 4l that has the gateway function being capable of exchanging data with the telephone 5l) exists in the IP routing table constructed by the OSI automatic routing function (seq 07). When the route to this IP address exists in the IP routing table, the NE 4g creates an OSI tunnel between the NE 4g and the NE 4l using the automatic OSI tunnel creation function. When doing so, in the NE 4g and the NE 41, the IP protocol processing section 20 executes the automatic OSI tunnel creation function (seq 08, seq 09). When the OSI tunnel creation is completed, the NE 4l issues a creation completion ACK to the NE 4g.

Also, in seq 10 in the first application example, according to the third application example, the NE 4g performs call establishment with respect to the telephone 5l in the public telephone network through the created OSI tunnel and via the NE 4l using a Q. 931 procedure.

Also, according to the third application example, the processing in seq 12 and later in the first application example is performed between the NE 4g and the NE 4l instead of between the NE 4g and the NE 4h in the first application example.

<Operation/Effect>

In the conventional order wire system, it is impossible to place a call to a telephone connected to a public telephone network. Therefore, conventionally, when a maintenance person wants to make telephone conversation with another maintenance person that is the other party in a public telephone network, it is required for him/her to use a mobile telephone or the like, so there occurs the same problem as in the case where it is impossible to make telephone conversation via the Internet.

According to the third application example of the present invention, however, telephone conversation is realized by using a standard such as H. 225 of H. 323 or Q. 931, so connection with a public telephone network becomes possible. Therefore, it becomes possible for a maintenance person to make telephone conversation with another maintenance person that is the other party via a public telephone network using the IP telephone client function, which eliminates the necessity to use another facility. Accordingly, it becomes possible to reduce costs relating to the usage of other facilities.

### FOURTH APPLICATION EXAMPLE

<System Structure>

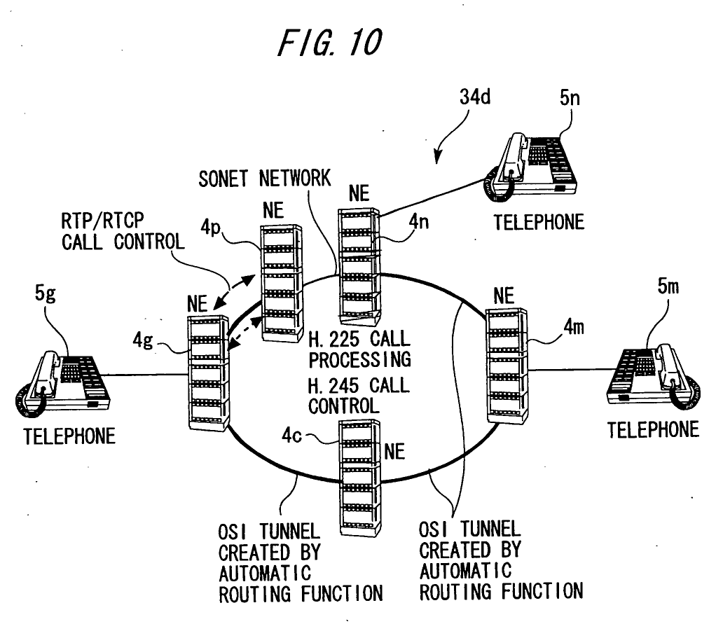

FIG. 10 shows a system structure in a fourth application example of the NEs 4 (4g, 4j, 4m, 4n, and 4p) formed using the transmitting apparatus according to the present invention. That is, a system structure of an order wire system 34d to which the NEs 4 are applied. First, using FIG. 10, the system structure in the fourth application example will be described.

In the order wire system 34d, a telephone conference is held in an optical network (SONET/SDH). That is, according to the order wire system 34d, in the optical network, voice telephone conversation by inter-multipoint communication is realized. Here, there exist inter-multipoint communication of concentrated type and inter-multipoint communication of not-concentrated type. In the fourth application example, the inter-multipoint communication of concentrated type will be described as an example, although the inter-multipoint communication of not-concentrated type may be performed in the system using the present invention. In order to realize such a telephone conference, the order wire system 34d is formed using the NEs 4g, 4j, 4m, 4n, and 4p constituting the SONET network and telephones 5g, 5m, and 5n. The telephones 5g, 5m, and 5n are directly connected to the NEs 4g, 4m, and 4n, respectively. In this case, the NEs 4g, 4m, and 4n have the IP telephone client function. Also, in the order wire system 34d, an apparatus having the gatekeeper function and an apparatus (MCU) having the inter-multipoint communication function are necessary, and the NE 4j and the NE 4p have these functions, respectively. The gatekeeper function and the inter-multipoint communication function may be possessed by other NEs 4 or may be possessed by other apparatuses (for instance, an apparatus dedicated to the gatekeeper function and an apparatus dedicated to the inter-multipoint communication function) that are different from the NEs 4 and are accessible from the NEs 4. Also, it is assumed that registration in the gatekeeper as to the IP telephone client function of the NEs 4g, 4m, and 4n, and the like is completed.

### OPERATION EXAMPLE

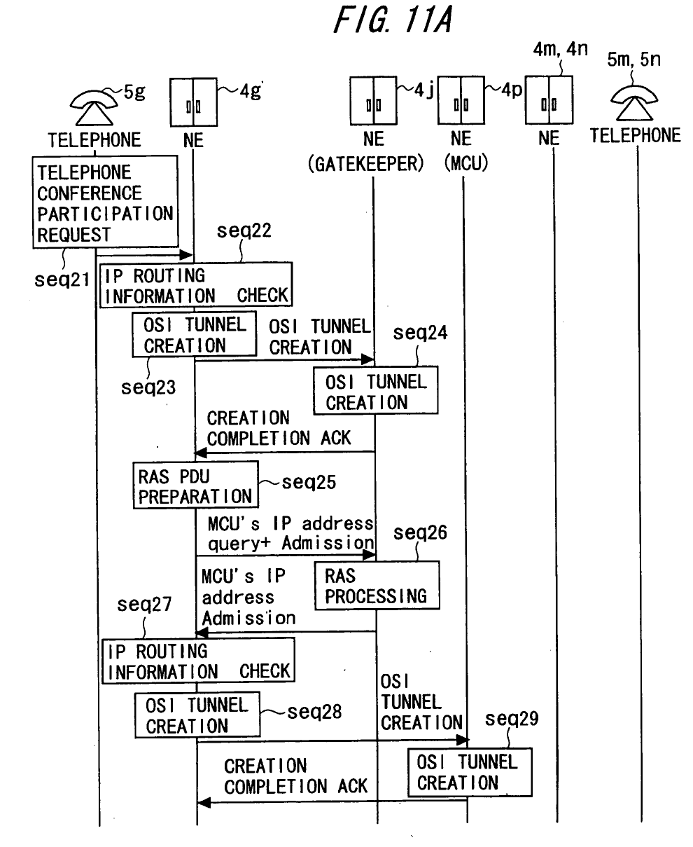

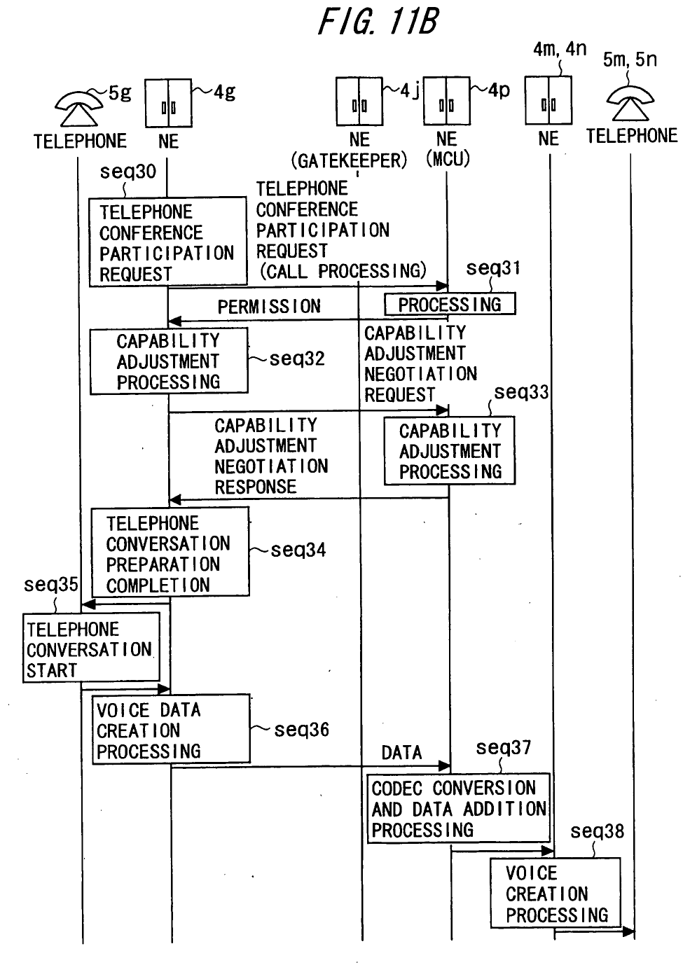

FIG. 11A and FIG. 11B show an operation sequence of the order wire system 34d in the fourth application example. Using FIG. 11A and FIG. 11B, an operation example of the order wire system 34d in the fourth application example will be described. Note that the operation sequence in FIG. 11A and FIG. 11B is an operation sequence until a telephone conference from the telephone 5g to the telephone 5m and the telephone 5n is started.

First, a user designates (inputs) the telephone number of a telephone conference, in which he/she wants to participate, using the telephone 5g (telephone conference participation request: seq 21).

Next, the NE 4g checks whether a route to the IP address of a gatekeeper registered in the local apparatus in advance (in the fourth application example, the IP address of the NE 4j) exists in the IP routing table constructed by the OSI automatic routing function (seq 22). When the route to the IP address of the NE 4j exists in the IP routing table, the NE 4g creates an OSI tunnel between the NE 4g and the NE 4j using the automatic OSI tunnel creation function. When doing so, in the NE 4g and the NE 4j, the IP protocol processing section 20 executes the automatic OSI tunnel creation function (seq 23, seq 24). When the OSI tunnel creation is completed, the NE 4j issues a creation completion ACK to the NE 4g.

On the other hand, when the route to this IP address does not exist in the IP routing table, the NE 4g informs the telephone 5g of an error and ends the processing.

When an IP route (OSI tunnel) to the NE 4j (gatekeeper) is created, the RAS processing section 28 of the NE 4g issues a request to obtain the IP address corresponding to the telephone number designated by the user and a band usage permission request to the NE 4j using RAS protocol. When doing so, the NE 4g informs the NE 4j of the telephone number designated by the user as the IP address obtainment request. At this time, the IP data extracting/IP data encapsulating section 19 encapsulates IP data that is a target of communication into CLNS PDU under OSI protocol, thereby issuing the IP address obtainment request and the band usage permission request (seq 25). The protocol stack of the data encapsulated into the CLNS PDU is as shown in FIG. 5.

The NE 4j issues, as a gatekeeper, a response with respect to the respects received from the NE 4g. That is, the NE 4j informs the NE 4g of the IP address corresponding to the requested telephone number (that is, the IP address of the NE 4p) and band usage permission (Admission) (seq 26).

The NE 4g checks whether a route to the IP address obtained from the NE 4j (that is, the IP address of the NE 4p) exists in the IP routing table constructed by the OSI automatic routing function (seq 27). When the route to this IP address exists in the IP routing table, the NE 4g creates an OSI tunnel between the NE 4g and the NE 4p using the automatic OSI tunnel creation function. When doing so, in the NE 4g and the NE 4p, the IP protocol processing section 20 executes the automatic OSI tunnel creation function (seq 28, seq 29). When the OSI tunnel creation is completed, the NE 4p issues a creation completion ACK to the NE 4g.

On the other hand, when the route to this IP address does not exist in the IP routing table, the NE 4g informs the telephone 5g of an error and ends the processing.

The NE 4g transmits a telephone conference participation request to the NE 4p through the created OSI tunnel using the H. 225 procedure (seq 30) and establishes connection for inter-multipoint communication (telephone conference) (seq 31).

The processing in seq 21 to seq 31 described above is performed also for the telephones 5m and 5n, and the NEs 4m and 4n.

When the establishment of the connection for the inter-multipoint communication at each of the telephones 5g, 5m, and 5n and each of the NEs 4g, 4m, and 4n is completed, each of the NEs 4g, 4m, and 4n determines a communication method (such as the specifications of a CODEC to be used) with the NE 4p using H. 245 protocol (capability adjustment processing: seq 32, seq 33). That is, each of the NEs 4g, 4m, and 4n issues a capability adjustment negotiation request to the NE 4p using H. 245 protocol. Then, the NE 4p issues a capability adjustment negotiation response to the NEs 4g, 4m, and 4n with respect to the request. On receiving the capability adjustment negotiation response, each of the NEs 4g, 4m, and 4n judges that a telephone conversation preparation is completed (seq 34).

Following this, a telephone conference is started at each of the telephones 5g, 5m, and 5n using the IP telephone client function in the NEs 4g, 4m, and 4n (seq 35). Hereinafter, a concrete operation example of the telephone conference will be described by taking an operation of the telephone 5g as an example. Analog voice data inputted from the telephone 5g is inputted into the NE 4g. The NE 4g performs voice data creation processing. For instance, the NE 4g creates digital voice data by performing AD conversion on the voice data inputted from the telephone 5g in accordance with the specifications of the CODEC determined in the capability adjustment processing (voice data creation processing: seq 36). Then, the NE 4g transmits this digital voice data to the NE 4p using RTP/RTCP. The NE 4p receives the transmitted digital voice data and CODEC-converts the received data in accordance with the specifications of the CODEC determined in the capability adjustment processing and performs data addition processing as necessary (seq 37). That is, when there exists voice data of the telephone conference transmitted from the NEs 4m and 4n to the NE 4p, this data is added to the data transmitted from the NE 4g. The NE 4p transmits this data (post-addition data when the data addition processing was performed) to the NEs 4 to which the telephones 5g, 5m, and 5n participating in the telephone conference are connected. That is, the NE 4p transmits this data to the NEs 4g, 4m, and 4n. The NEs 4g, 4m, and 4n receives the transmitted data and creates analog voice data using the received data (seq 38). Then, the NEs 4g, 4m, and 4n transmit the created analog voice data to the telephones 5g, 5m, and 5n, respectively.

<Operation/Effect>

According to the fourth application example of the present invention, the inter-multipoint communication function is used, so conversation between plural transmitting apparatuses using the IP telephone client function becomes possible. That is, a telephone conference becomes possible. Therefore, unlike in the case of the conventional digital through, plural maintenance persons can participate in conversation while preventing degradation of voice.

[Modifications]

In this embodiment, a protocol stipulated by H. 323 of ITU-T is used as an IP telephone system, although another IP telephone standard (SIP, for instance) may be used instead.

Also, in the OSI tunnel in this embodiment, as a method of mapping IP data to DCC, a method is used with which IP data is encapsulated into CLNS PDU stipulated by ISO8473, although another method, such as IP over DCC, may be used instead.

Also, in the first application example to the fourth application example, a user uses the telephone connected to the NE 4 in advance to make telephone conversation with the telephone of the other party or the IP telephone client, although a user may make the telephone conversation by newly connecting a telephone to the NE 4. In this case, however, it is required that the NE 4, to which a user newly connects the telephone, has the IP telephone client function like, for instance, the NEs 4g and 4h in the first application example.

1. A transmitting apparatus provided in a network different from Internet Protocol (IP), comprising:
an IP telephone control unit implementing an IP telephone function by dealing with IP data including voice information;
an encapsulating unit encapsulating the IP data dealt with by the IP telephone control unit into data suitable for a protocol of the network in which this transmitting apparatus is provided;
a transmitting unit transmitting the data encapsulated by the encapsulating unit to the network;
a receiving unit receiving data encapsulated by the encapsulating unit of another transmitting apparatus, via the network; and
an extracting unit extracting IP data from the data received by the receiving unit.

2. A transmitting apparatus provided at a boundary between a network different from Internet Protocol (IP) and an IP network, comprising:
an exchanging unit exchanging IP data with the IP network;
an encapsulating unit encapsulating IP data received from the IP network into data suitable for a protocol of the network different from IP;
a transmitting unit transmitting the data encapsulated by the encapsulating unit, to the network different from IP;
a receiving unit receiving data encapsulated by another apparatus into data suitable for the protocol of the network different from IP, via the network different from IP;
an extracting unit extracting IP data from the data received via the network different from IP; and
an IP routing unit routing the IP data extracted by the extracting unit with respect to the IP network.

3. A transmitting apparatus provided at a boundary between a network different from Internet protocol (IP) and a public telephone network, comprising:
an exchanging unit exchanging analog data with the public telephone network;
a data conversion unit performing data conversion between analog data received via the public telephone network and data used in an IP telephone function;
an encapsulating unit encapsulating the data used in the IP telephone function into data suitable for a protocol of the network different from IP;
a transmitting unit transmitting the data encapsulated by the encapsulating unit to the network different from IP;
a receiving unit receiving data encapsulated by another apparatus into data suitable for the protocol of the network different from IP, via the network different from IP; and
an extracting unit extracting data used in the IP telephone function, from the data received via the network different from IP.

4. A transmitting apparatus provided in a network different from Internet Protocol (IP), comprising:
an inter-multipoint control unit controlling an inter-multipoint IP telephone function;
an encapsulating unit encapsulating IP data dealt with by the inter-multipoint control unit into data suitable for a protocol of the network different from IP;
a transmitting unit transmitting the data encapsulated by the encapsulating unit, to the network different from IP;
a receiving unit receiving data encapsulated by another apparatus into data suitable for the protocol of the network different from IP, via the network different from IP; and
an extracting unit extracting IP data from the data received by the receiving unit.

5. A transmitting apparatus according to claim 1, further comprising:
a path storing unit storing a communication path to each of other transmitting apparatuses by performing communication with other transmitting apparatus provided in the same network.

6. A transmitting apparatus according to claim 5, further comprising:
a path control unit, when a fault occurred to a path of the network, controlling the transmitting unit to transmit the encapsulated data via a path that is stored in the path storing unit excluding the path to which the fault occurred.

7. A transmitting apparatus according to claim 1, further comprising:
an IP path storing unit obtaining a network address of an IP network, to which each of other transmitting apparatuses provided in the same network is connected, by performing communication with each of other transmitting apparatuses, and storing the IP address and each of other transmitting apparatuses so as to be associated with each other.

8. A telephone conversation system formed using a network different from Internet Protocol (IP) and an IP network, comprising:
a transmitting apparatus including IP telephone control unit implementing an IP telephone function by dealing with IP data including voice information, an encapsulating unit encapsulating the IP data dealt with by the IP telephone control unit into data suitable for a protocol of the network different from IP, a transmitting unit transmitting the data encapsulated by the encapsulating unit to the network different from IP, a receiving unit receiving data encapsulated by another apparatus into data suitable for the protocol of the network different from IP, via the network different from IP, and an extracting unit extracting IP data from the data received by the receiving unit;
an IP routing transmitting apparatus including an exchanging unit exchanging IP data with the IP network, an encapsulating unit encapsulating IP data received from the IP network into data suitable for the protocol of the network different from IP, a transmitting unit transmitting the data encapsulated by the encapsulating unit of this IP routing transmitting apparatus, to the network different from IP, a receiving unit receiving data encapsulated by another apparatus into data suitable for the protocol of the network different from IP, via the network different from IP, an extracting unit extracting IP data from the data received via the network different from IP, and an IP routing unit routing the IP data extracted by the extracting unit of this IP routing transmitting apparatus with respect to the IP network; and
an IP telephone client including an IP telephone control unit, which is connected to the IP network, for implementing the IP telephone function by dealing with IP data including voice information, and an exchanging unit exchanging IP data with the IP routing transmitting apparatus via the IP network.

9. A telephone conversation system formed using a network different from Internet Protocol (IP) and a public telephone network, comprising:
a transmitting apparatus including an IP telephone control unit implementing an IP telephone function by dealing with IP data including voice information, an encapsulating unit encapsulating the IP data dealt with by the IP telephone control unit into data suitable for a protocol of the network different from IP, a transmitting unit transmitting the data encapsulated by the encapsulating unit to the network different from IP, a receiving unit receiving data encapsulated by another apparatus into data suitable for the protocol of the network different from IP via the network different from IP, and an extracting unit extracting IP data from the data received by the receiving unit;
a gateway transmitting apparatus including an analog data exchanging unit exchanging analog data with the public telephone network, a data conversion unit performing conversion between analog data received via the public telephone network and data used in the IP telephone function, an encapsulating unit encapsulating the data used in the IP telephone function into data suitable for the protocol of the network different from IP, a transmitting unit transmitting the data encapsulated by the encapsulating unit of the local apparatus to the network different from IP, a receiving unit receiving data encapsulated by another apparatus into data suitable for the protocol of the network different from IP, via the network different from IP, and an extracting unit extracting data used in the IP telephone function from the data received via the network different from IP; and
a telephone that is connected to the public telephone network and deals with the analog data.

10. A telephone conversation system formed using a network different from Internet Protocol (IP), comprising:
a transmitting apparatus including an IP telephone control unit implementing an IP telephone function by dealing with IP data including voice information, an encapsulating unit encapsulating the IP data dealt with by the IP telephone control unit into data suitable for a protocol of the network different from IP, a transmitting unit transmitting the data encapsulated by the encapsulating unit to the network different from IP, a receiving unit receiving data encapsulated by another apparatus into data suitable for the protocol of the network different from IP, via the network different from IP, and an extracting unit extracting IP data from the data received by the receiving unit; and
an inter-multipoint control transmitting apparatus including an inter-multipoint control unit controlling an inter-multipoint IP telephone function, an encapsulating unit encapsulating IP data dealt with by the inter-multipoint control unit into data suitable for the protocol of the network different from IP, a transmitting unit transmitting the data encapsulated by the encapsulating unit of this inter-multipoint control transmitting apparatus, to the network different from IP, a receiving unit receiving data encapsulated by another apparatus into data suitable for the protocol of the network different from IP, via the network different from IP, and an extracting unit extracting IP data from the data received by the receiving unit of this inter-multipoint control transmitting apparatus.

11. A transmitting apparatus accommodated in a network in which data is transmitted in accordance with a protocol different from Internet Protocol (IP), comprising:
a tunnel generating unit generating tunnels for transferring IP-related data, between predetermined transmitting apparatuses accommodated in the network; and
a call establishing unit establishing an IP telephone call via the network, through cooperation with other transmitting apparatuses accommodated in the network using one or more tunnels generated by the tunnel generating unit.

12. A telephone system comprising:
a tunnel generating unit generating tunnels for transferring IP-related data between predetermined nodes in a network in which data is transmitted in accordance with a protocol different from Internet Protocol (IP); and
a call establishing unit establishing an IP telephone call via the network using one or more tunnels generated by the tunnel generating unit.
